(19) United States
(12) Patent Application Publication
(10) Pub. No.: US 2004/0108683 A1
(43) Pub. Date: Jun. 10, 2004

(54) POWER STABILIZING APPARATUS FOR A BICYCLE ELECTRICAL COMPONENT

(75) Inventor: Kouji Oohara, Sakai-shi (JP)

Correspondence Address: DELAND LAW OFFICE, P.O. BOX 69, KLAMATH RIVER, CA, 96050-0069, US

(73) Assignee: SHIMANO, INC., Sakai (JP)

(21) Appl. No.: 10/604,813

(22) Filed: Aug. 19, 2003

(30) Foreign Application Priority Data
Aug. 20, 2002 (JP) 2002-239245

(51) Int. Cl. B62J 6/00

(52) U.S. Cl. 280/288.4; 318/521

(57) ABSTRACT

A bicycle electrical control circuit provides power and control signals to a plurality of bicycle components. The circuit comprises a power circuit that provides a power signal for the plurality of bicycle components, a control circuit that provides a control signal that controls at least one of the plurality of bicycle components, and a power stabilizing circuit coupled to the power circuit. The power stabilizing circuit stabilizes power provided from the power signal to at least one of the plurality of bicycle components.

### BACKGROUND OF INVENTION

The present invention is directed to bicycles and, more particularly, to an apparatus for stabilizing power provided to a bicycle electrical component.

In recent years, bicycles have been equipped with a variety of electrical components. Such electrical components include cycle computers for displaying a travel status (e.g., speed) of the bicycle, and controllers for automatically changing the gears of a gear-shift mechanism. Conventionally, power has been supplied to these types of electrical components from a battery, wherein a power line is connected from the battery to the electrical component. Also, a control signal line may be connected between the electrical component and an associated sensor or controller for exchanging signals. As the number of electrical components increase, the number of power and control signal lines increase accordingly. In the case of a bicycle, since wires other than these power and control signal lines are already attached to the frame and handlebar for brake and gear-shift operations, further increasing the number of wires is not desirable.

Technology for communicating power and control signals using integrated or composite signals has been developed to reduce the number of wires required between the various electrical components. Such signals sometimes take the form of pulsed signals wherein the signal is repetitively turned on and off. Some electrical components operate using both the power and control components of the signals, whereas other electrical components may operate using only the power component of the signals. Unfortunately, when power and control signals are communicated using such pulsed signals, there is a risk that an electrical component that does not use the control component of the signals will not function properly. For example, an illumination device may flicker as a result of the ON/OFF nature of the pulsed signals.

### SUMMARY OF INVENTION

The present invention is directed to various features of an apparatus for providing power and control signals to a plurality of bicycle components. In one embodiment, a bicycle electrical control circuit provides power and control signals to a plurality of bicycle components. The circuit comprises a power circuit that provides a power signal for the plurality of bicycle components, a control circuit that provides a control signal that controls at least one of the plurality of bicycle components, and a power stabilizing circuit coupled to the power circuit. The power stabilizing circuit stabilizes power provided from the power signal to at least one of the plurality of bicycle components. Additional inventive features will become apparent from the description below, and such features alone or in combination with the above features may form the basis of further inventions as recited in the claims and their equivalents.

### BRIEF DESCRIPTION OF DRAWINGS

FIG. 1 is a side view of a bicycle including a circuit that provides power and control signals to a plurality of bicycle components;

FIG. 2 is an enlarged oblique view of the bicycle handlebar assembly;

FIG. 3 is a block diagram of a particular embodiment of a circuit that provides power and control signals to a plurality of bicycle components;

FIG. 4 is a cross sectional view of a cycle computer display and associated backlight; and

FIG. 5 is a schematic diagram of a particular embodiment of a power stabilizing circuit.

### DETAILED DESCRIPTION

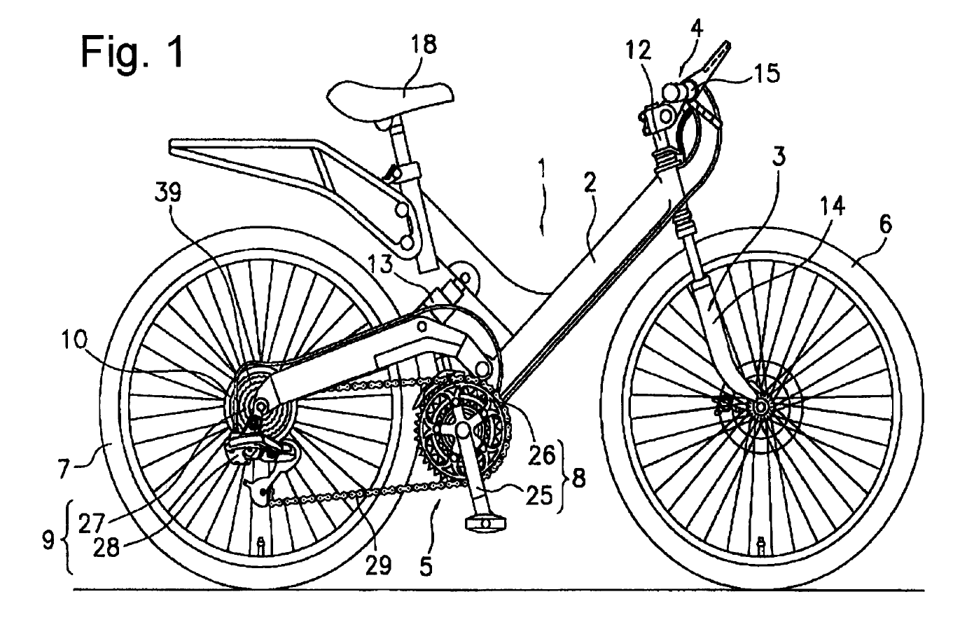

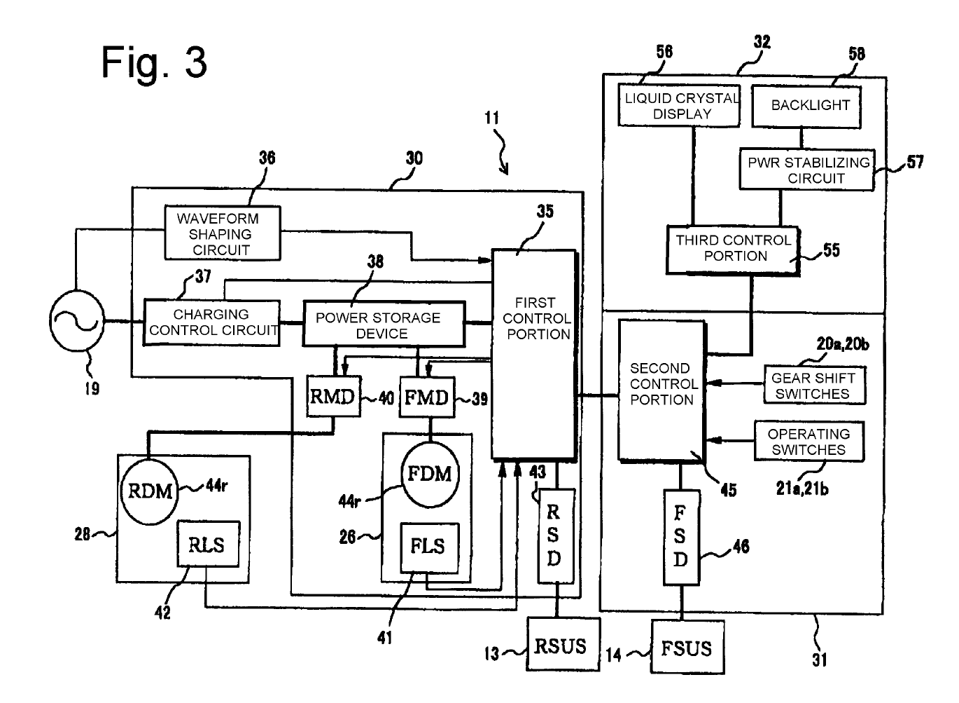

FIG. 1 is a side view of a bicycle including a circuit that provides power and control signals to a plurality of bicycle components. In this embodiment, the bicycle is a mountain bicycle comprising a frame 1 having a frame body 2; a front fork 3 mounted to the front of frame body 2 for rotation around an inclined axis; a front wheel 6 rotatably mounted to front fork 3; a handlebar assembly 4 mounted to the upper portion of front fork 3; a rear wheel 7 rotatably mounted to the rear portion of frame body 2, a driving portion 5 comprising front and rear gear-shift mechanisms 8 and 9; and a controller 11 (FIG. 3) for controlling the front and rear gear-shift mechanisms 8 and 9. A front suspension 14 is mounted to front fork 3, a rear suspension 13 is mounted to the rear of frame body 2, and a saddle 18 is mounted to the middle of frame body 2.

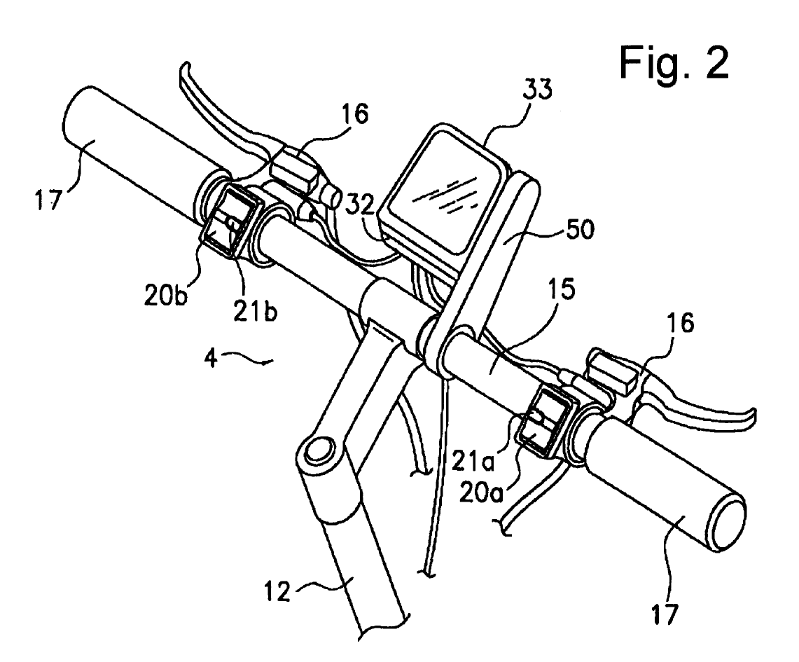

As shown in FIG. 2, handlebar assembly 4 comprises a handle stem 12 and a handlebar 15, wherein handle stem 12 is fastened to the upper portion of the front fork 3, and handlebar 15 is fastened to handle stem 12. Brake levers 16 and grips 17 are mounted at opposite ends of the handlebar 15. Gear-shift switches 20a and 20b are provided for carrying out manual gear-shift operations of the front and rear gear-shift mechanisms 8 and 9. An operating switch 21a is provided for switching between an automatic mode and a manual mode of operation, and an operating switch 21b is provided for manually adjusting the stiffness of the front and rear suspensions 13 and 14.

Front gear-shift mechanism 8 comprises a gear crank 25 rotatably mounted at a bottom bracket portion of frame body 2. A plurality of front sprockets (e.g., three sprockets) are mounted to gear crank 25, and a front derailleur 26 is mounted to frame body 2 in close proximity to gear crank 25 for switching a chain 29 among the plurality of front sprockets. Rear gear-shift mechanism 9 comprises a plurality of rear sprockets 27 (e.g., nine sprockets), and a rear derailleur 28 is mounted to the rear of frame body 2 for switching chain 29 among the plurality of rear sprockets 27.

A dynamo hub 10 is mounted to rear wheel 7. Dynamo hub 10 is structured to support a brake disk (not shown), and it includes a freewheel assembly to which the plurality of rear sprockets 27 are mounted. An alternating current generator 19 (FIG. 3) is mounted inside hub 10 for generating power in response to the rotation of the rear wheel 7.

Controller 11 manually controls the front and rear gear-shift mechanisms 8 and 9 and front and rear suspensions 13 and 14 in response to the operation of the gear-shift switches 20a and 20b and operating switches 21a and 21b. Controller 11 also may automatically control the front and rear gear-shift mechanisms 8 and 9 and front and rear suspensions 13 and 14 in accordance with the speed of the bicycle. As shown in FIG. 3, controller 11 has a first control unit 30, a second control unit 31, and a third control unit 32. First control unit 30 may be integrally assembled with front derailleur 26. First control unit 30 is connected to and is powered by the alternating current generator 19, and it powers and controls the front and rear derailleurs 26 and 28 and rear suspension 13. Since first control unit 30 is provided close to the alternating current generator 19, a shorter power cable may be used, thus increasing the efficiency of control signal exchanges and power supply.

The first control unit 30 includes a first control portion 35 in the form of a microcomputer (an example of both a power circuit and a control circuit), a waveform-shaping circuit 36 (an example of a control circuit) for generating a speed signal derived from the output of the alternating current generator 19, a charging control circuit 37, a power storage device 38 (an example of a power circuit), a front derailleur motor driver (FMD) 39, a rear derailleur motor driver (RMD) 40, a front derailleur 26 operating location (position) sensor (FLS) 41, a rear derailleur 28 operating location (position) sensor (RLS) 42, and a rear suspension motor driver (RSD) 43. The charging control circuit 37 rectifies the power output from the alternating current generator 19 and produces direct current power. The power storage device 38 may comprise a large-capacity capacitor, for example, for storing the direct current power produced by charging control circuit 37. If desired, the power storage device 38 may comprise a secondary storage battery such as a nickel cadmium battery, lithium ion battery, nickel hydride battery, etc. instead of a capacitor. The power stored in the power storage device 38 is communicated to the first control portion 35 and to the motor drivers 39, 40 and 43. The motor drivers 39, 40 and 43 output driving signals for driving motors 44f and 44r used to control derailleurs 26 and 28 and a motor (not shown in the figure) used to control the rear suspension 13 in accordance with control signals from first control portion 35.

The first control unit 30 also supplies power and control signals to the second control unit 31 and third control unit 32. More specifically, the first control unit 30 provides composite power/control signals that are pulsed ON and OFF (thus functioning as a power/control circuit). The control signals may include the speed signals from waveform-shaping circuit 36. The second control unit 31 and third control unit 32 derive power from the power signal components of the composite signals and are controlled according to control signal components of the composite signals.

The second control unit 31 is mounted via a bracket 50 (FIG. 2) to the handlebar 15 of the handlebar assembly 4. The second control unit 31 comprises gear-shift switches 20a and 20b, operating switches 21a and 21b, a second control portion 45 in the form of a microcomputer, and a front suspension motor driver (FSD) 46. The second control unit 31 transfers the operating data of switches 20a, 20b, 21a and 21b to the first control unit 30. In automatic mode, second control portion 45 adjusts the stiffness of the front suspension 14 in accordance with a control signal sent from the first control unit 30 based on bicycle speed. In manual mode, second control portion 45 adjusts the stiffness of the front suspension 14 in accordance with the operation of the operating switch 21b.

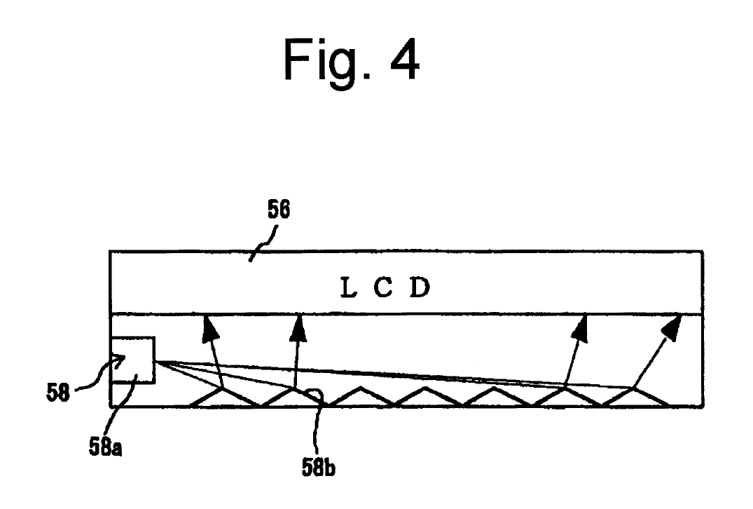

The third control unit 32 is a so-called cycle computer, and it is detachably mounted to the second control unit 31. The third control unit 32 has a third control portion 55 in the form of a microcomputer, a liquid crystal display portion 56, and a backlight 58. Backlight 58 is coupled to third control portion 55 through a power stabilizing circuit 57. The liquid crystal display portion 56 is capable of displaying various data such as speed, cadence, travel distance, gear-shift location, suspension status and so forth, and it is illuminated by the backlight 58. As shown in FIG. 4, the backlight 58 is disposed on the opposite side of the display screen of the liquid crystal display portion 56. Backlight 58 comprises a light source such as an LED 58a, for example, and a diffused reflecting portion 58b for diffusing and reflecting the light of the LED 58a, thus illuminating the liquid crystal display portion 56.

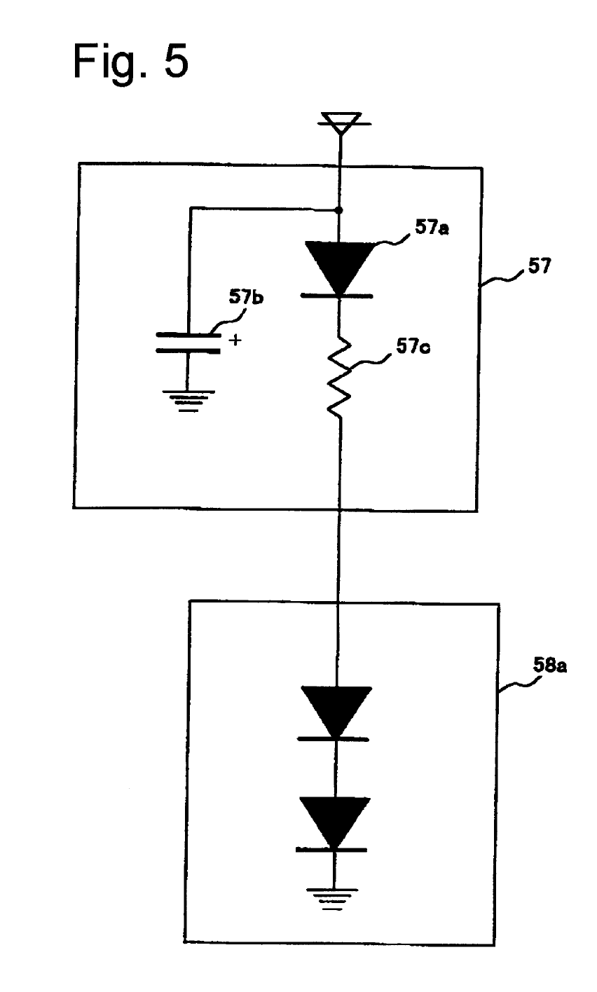

As shown in FIG. 5, the power stabilizing circuit 57 comprises a diode 57a (the anode of which is connected to the third control portion 55), a resistor 57c connected in series between diode 57a and LED 58a for regulating current supplied to LED 58a, and a capacitor 57b connected in parallel with the resistor 57c. One terminal of capacitor 57b is connected to the anode of diode 57a, and the other terminal of capacitor 57b is grounded. The diode 57a prevents reverse current when the capacitor 57b is being charged. The capacitor 57b stabilizes the voltage supplied to the LED 58a and lessens a voltage drop resulting from the pulsed ON/OFF nature of the control signal, even if it is the same large signal used to power and control the derailleur or motor drivers 39, 40, 43 or 46. This, in turn, minimizes or prevents flickering of the LED 58a.

In operation, the alternating current generator 19 of the dynamo hub 10 generates electric power when the bicycle is traveling, and the electric power is stored in the power storage device 38. Since the generator 19 is provided on the rear wheel 7, the power storage device 38 also may be charged by putting the bicycle on its stand and rotating the pedals if the charge produced by normal travel is insufficient. This is particularly helpful when adjusting the gear-shift mechanisms and setting the operations of the liquid crystal display portion 56.

When the bicycle speed either exceeds a predetermined threshold value or falls below a predetermined threshold value in automatic mode, a gear-shift operation is carried out. In this embodiment, the gear-shift operation is carried out with priority given to the rear derailleur 28. Furthermore, when the speed exceeds a predetermined speed, the stiffness of both suspensions 13 and 14 may be made stiffer. A pulsed composite power/control signal for controlling the liquid crystal display portion 56 or front suspension 14 is generated by the first control portion 35 and communicated to the second control portion 45 and to the third control portion 55. The composite power/control signal sent to the third control portion 55 is also sent to the backlight 58 via the power stabilizing circuit 57. The control portion of the composite signal does not control the backlight 58, but there is the danger that backlight 58 may be affected by the ON/OFF pulsed nature of the composite signal. However, the capacitor 57c is charged during the ON portion of the composite signal, and this charged power is supplied to the LED 58a of the backlight 58 during the OFF portion of the composite signal. Thus, the backlight 58 is not apt to flicker even when such a pulsed signal is used.

While the above is a description of various embodiments of inventive features, further modifications may be employed without departing from the spirit and scope of the present invention. For example, a backlight was given as an example of an electrical component that is powered by but not controlled by a composite power/control signal, but such an electrical component may comprise other electrical components for a bicycle such as, for example, a headlight or taillight, or some other lighted or non-lighted component. Although an alternating current generator which does not have to be periodically replaced was given as an example of a power source, a direct current power source such as a primary battery or a secondary battery also may be used as the power source to reduce weight. Although a dynamo hub was mounted to the rear wheel in the described embodiment, a dynamo hub may be mounted to the front wheel, or a rim dynamo may be provided to generate power by making contact with the rim of a wheel.

The size, shape, location or orientation of the various components may be changed as desired. Components that are shown directly connected or contacting each other may have intermediate structures disposed between them. The functions of one element may be performed by two, and vice versa. The structures and functions of one embodiment may be adopted in another embodiment. It is not necessary for all advantages to be present in a particular embodiment at the same time. Every feature that is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus or emphasis on a particular structure or feature.

1. A bicycle electrical control circuit that provides power and control signals to a plurality of bicycle components, wherein the circuit comprises:
a power circuit that provides a power signal for the plurality of bicycle components;
a control circuit that provides a control signal that controls at least one of the plurality of bicycle components; and
a power stabilizing circuit coupled to the power circuit, wherein the power stabilizing circuit stabilizes power provided from the power signal to at least one of the plurality of bicycle components.

2. The circuit according to claim 1 wherein the control signal has a pulse component.

3. The circuit according to claim 2 wherein the control signal has an ON component and an OFF component.

4. The circuit according to claim 1 wherein the power stabilizing circuit stabilizes a voltage provided to the at least one of the plurality of bicycle components.

5. The circuit according to claim 1 wherein the power stabilizing circuit comprises a capacitor.

6. The circuit according to claim 5 wherein the power stabilizing circuit further comprises a diode coupled to prevent reverse current to the power circuit.

7. The circuit according to claim 1 wherein the power circuit is structured to provide power derived from an alternating current source.

8. The circuit according to claim 7 wherein the power circuit is structured to provide power from a dynamo hub mounted to one of a front wheel or a rear wheel of the bicycle.

9. The circuit according to claim 1 wherein the power circuit is structured to provide power derived from a direct current source.

10. The circuit according to claim 9 wherein the power circuit is structured to provide power derived from a battery.

11. The circuit according to claim 1 wherein the power circuit and the control circuit together comprise a power/control circuit that provides a composite signal having the power signal and the control signal.

12. The circuit according to claim 11 wherein the control signal has a pulse component.

13. The circuit according to claim 12 wherein the control signal has an ON component and an OFF component.

14. The circuit according to claim 13 wherein the plurality of bicycle components comprises a first electrical component and a second electrical component, wherein the first electrical component is controlled by the control signal, and wherein the second electrical component is not controlled by the control signal.

15. The circuit according to claim 14 wherein the power stabilizing circuit stabilizes the power provided from the power signal to the second electrical component.

16. The circuit according to claim 15 wherein the first electrical component comprises a liquid crystal display component structured to display various data, and wherein the second electrical component comprises a backlight that illuminates the liquid crystal display component.

17. The circuit according to claim 15 wherein the first electrical component comprises a gear shift driving component that drives a gear shift mechanism having a plurality of gear ratios.

18. The circuit according to claim 17 wherein the second electrical component comprises a light.

19. The circuit according to claim 15 wherein the power stabilizing circuit stabilizes a voltage provided to the second component.

20. The circuit according to claim 19 wherein the power stabilizing circuit comprises a power storage device coupled in parallel with the second electrical component.

21. The circuit according to claim 20 wherein the power storage device comprises a capacitor.

22. The circuit according to claim 20 wherein the power stabilizing circuit further comprises a diode coupled to prevent reverse current to the power/control circuit.
